(19) United States
(12) Patent Application Publication
(10) Pub. No.: US 2008/0310660 A1
(43) Pub. Date: Dec. 18, 2008

(54) METHOD AND APPARATUS FOR HEARING ASSISTANCE DEVICE USING SUPERHYDROPHOBIC COATINGS

(75) Inventor: Weili LIN, Plymouth, MN (US)

Correspondence Address: SCHWEGMAN, LUNDBERG & WOESSNER, P.A., P.O. BOX 2938, MINNEAPOLIS, MN, 55402, US

(73) Assignee: Starkey Laboratories, Inc., eden praire, MN (US)

(21) Appl. No.: 12/138,267

(22) Filed: Jun. 12, 2008

Related U.S. Application Data
(60) Provisional application No. 60/943,475, filed on Jun. 12, 2007.

(51) Int. Cl. H04R 25/00

(52) U.S. Cl. 381/322

(57) ABSTRACT

The present subject matter includes methods and apparatus for coating of hearing assistance devices with superhydrophobic coatings designed to reduce the foregoing unwanted effects of wax, moisture and other unwanted materials. In some embodiments a superhydrophobic nanocoating is used to resist accumulation of wax, moisture and other unwanted materials near a transducer of a hearing assistance device, including, but not limited to hearing aids.

### RELATED APPLICATION

This application claims the benefit of U.S. Provisional Patent Application Ser. No. 60/943,475 filed Jun. 12, 2007, which is incorporated herein by reference and made a part hereof.

### FIELD OF THE INVENTION

The present application relates to hearing assistance devices and in particular to hearing assistance devices using superhydrophobic coatings

### BACKGROUND

One of the recurring problems with any body worn device having transducers is the accumulation of material that might block the proper operation of the transducer. Hearing assistance devices which are body worn and which have one or more transducers frequently encounter an accumulation of moisture, wax or other foreign material which can occlude apertures for the transducers and cause damage to the transducers eventually. One example of a hearing assistance device is a hearing aid. Hearing aids have apertures for reception of sound which can be blocked by moisture, wax or other material. Hearing aids may use protective screens, such as a waxceptor, microphone cover, or other acoustic screens which are intended to reduce the amount of unwanted substances that can reach the transducer. However, occlusion and other effects of the buildup of wax, moisture and other materials continue to be an issue with such devices.

What is needed in the art is a way to provide enhanced protection against the buildup of wax, moisture or other materials on hearing assistance devices. Such method and apparatus should not only improve the longevity of the transducers, but also provide reduced occurrences of partial or full blockage of apertures used for sound reception by hearing assistance devices.

### SUMMARY

The present subject matter includes methods and apparatus for coating of hearing assistance devices with superhydrophobic coatings designed to reduce the foregoing unwanted effects of wax, moisture and other unwanted materials. In some embodiments a superhydrophobic nanocoating is used to reduce the amount of wax, moisture and other unwanted materials reaching the transducer of a hearing assistance device, including, but not limited to hearing aids.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIGS. 1A-1D show one example of coated portions of a behind-the-ear hearing aid, according to one example of the present subject matter.

FIG. 2 shows one example of the area coated with a superhydrophobic coating on the front surface of a mounting tab of one behind-the-ear device example, according to one embodiment of the present subject matter.

FIG. 3 shows one example of the area coated with a superhydrophobic coating on the top of a case of one behind-the-ear device example, according to one embodiment of the present subject matter.

FIG. 4 shows one example of the area coated with a superhydrophobic coating on a rear microphone hood of one behind-the-ear device example, according to one embodiment of the present subject matter.

### DETAILED DESCRIPTION

The following detailed description of the present subject matter refers to subject matter in the accompanying drawings which show specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present subject matter includes method and apparatus using a superhydrophobic coating for a hearing assistance device. The following examples will be provided for a hearing aid, which is only one type of hearing assistance device. It is understood however, that the disclosure is not limited to hearing aids and that the teachings provided herein can be applied to a variety of hearing assistance devices.

In the example of a hearing aid, several embodiments are provided in which a superhydrophobic coating is used to reduce the effects of wax, moisture, and other unwanted substances.

Superhydrophobic phenomenon can be found in many plants, such as lotus leaves, which have leaves with a superhydrophobic surface as the basis of a self-cleaning mechanism. In this case, water droplets completely roll off the leaves and carry the dirt and mud with them at the same time. This self-cleaning or lotus effect is caused by both the hierarchical roughness of the leaf surface (composed of micrometer sized papillae), and the intrinsic hydrophobicity of a surface layer covering these papillae. The roughness enhances the natural non-wetting nature of the surface, leading to very large contact angles (150° or higher) for a liquid drop on the surface.

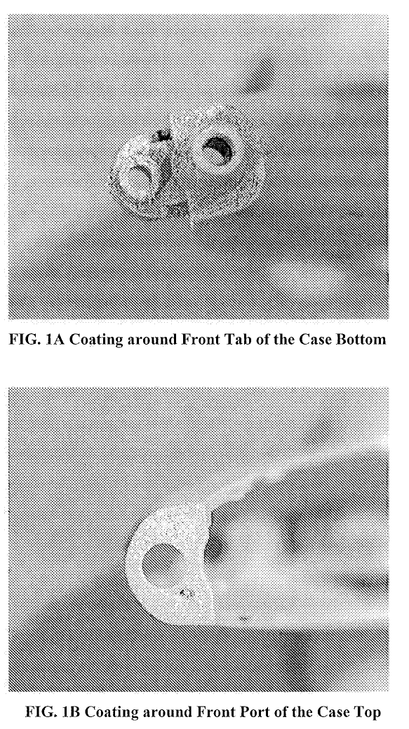

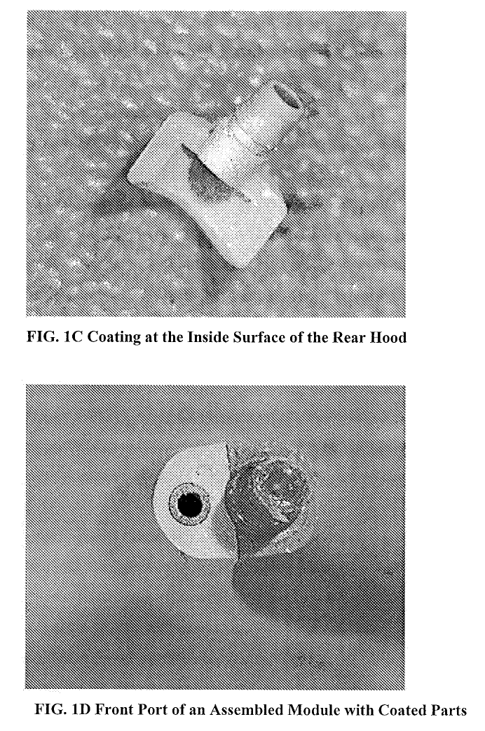

In reality, this lotus effect can be achieved by introducing textures on the surface of interest at nano scale (such as nano tube forest, nano particles, or etching) through photochemical treatment. One example of the surface texturing can be seen in FIG. 1, in which a feature height of about 10 nanometers to 1 micrometer are provided to make it difficult for moisture and wax to accumulate on the surface without rolling off. One source of nanocoating is a company called ISurTec. Other sources exist, such as a company named nGimat. There are additional sources and processes to those mentioned herein, which are intended to demonstrate ways of making and using the present subject matter and are not intended in an exclusive or exhaustive sense.

The areas of coating may vary. However, in one embodiment, a nanocoating is applied to a port area of a case of a hearing aid. In behind-the-ear hearing aids (BTEs), there may be a front and a rear port portions. Both portions may be coated to provide a reduced chance of buildup of wax, moisture, and other unwanted material. In some embodiments a protective screen and/or cover may be coated with the superhydrophobic coating to reduce accumulation of wax, moisture, and other unwanted material. In some embodiments, the port area and screen and/or cover areas may be coated with the superhydrophobic coating to prevent buildup of wax, moisture, and other unwanted material.

It is understood that any surface coating that provides a feature height somewhere between 10 nanometers to 1 micrometers may be employed to form the superhydrophobic layer.

In order to evaluate the effectiveness of the superhydrophobic nano coating, several hearing aid parts were treated, which in one example included the front port area in both the case top and bottom, and rear microphone hood (as shown in FIG. 1). Afterwards, ten microphone modules (five controlled and five nano coated) were assembled and were subjected to accelerated aging experiments in salt fog chamber following a sequence defined to test the efficacy of the coatings.

The coatings are made in areas which will resist wax, moisture, and other unwanted materials. In one embodiment, the coatings are made in the port region near a microphone. In multi-microphone embodiments, the coatings may be on all or some of the port regions of a hearing assistance device. The coatings may be small enough not to interfere with fit of the components and may be in an area where the coatings will not be damaged in either assembly or use.

In one example, superhydrophobic nanocoatings were applied to the case of a BTE near the microphone port. For example, the nanocoatings were applied to the front tab of a case bottom, around the front port of the case top, and to the inside surface of a rear hood of the hearing aid. In one embodiment, nanocoatings were applied to the screen of the microphone to avoid buildup of wax, moisture and other unwanted materials.

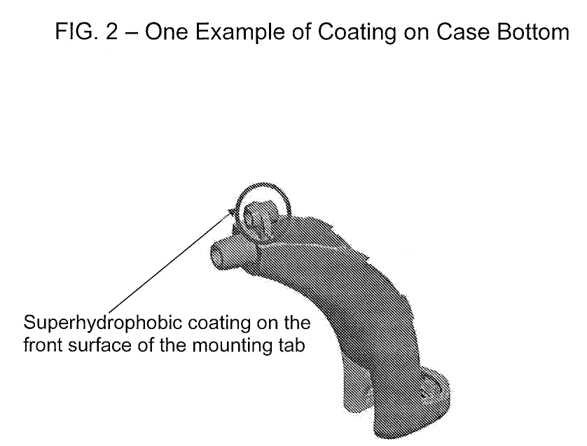

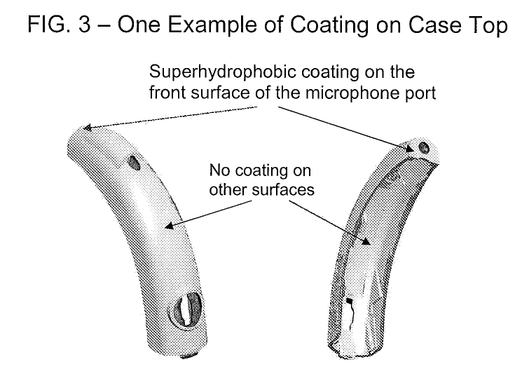

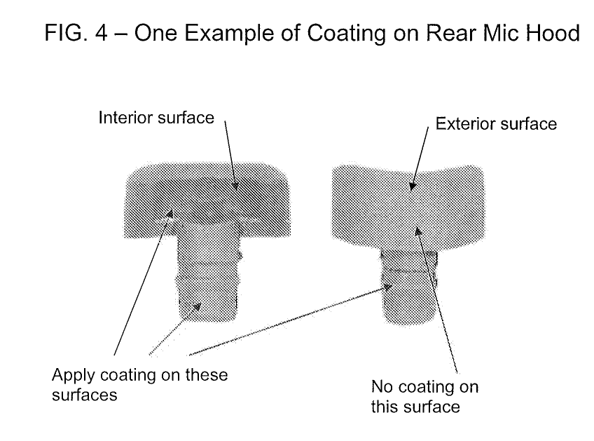

In one such test a BTE shell was coated in certain areas of its case bottom (see FIG. 2), its case top (see FIG. 3) and its rear microphone hood (see FIG. 4). These areas were used to demonstrate that the coatings did allow the device to avoid the deleterious effects of wax, moisture, and other unwanted materials. These coating areas are useful, but not intended to be exhaustive or exclusive of the areas in which the coating can yield benefits. Thus, the examples set forth herein are intended to demonstrate only some applications of the present subject matter. Other coatings, locations, parts, and assemblies are therefore contemplated that are not expressly set forth herein. The following samples were prepared and tested:

a.) Frequency responses of each omni and directional capsule were measured in a plane wave tube (PWT) prior to the experiment to establish baseline information;

b.) All ten modules were then exposed to a salt mist for sixteen hours continuously;

c.) Frequency responses of each omni and directional capsule were re-measured in PWT as soon as they were removed from the salt fog chamber (labeled as “Wet” condition);

d.) After being dried out for eight hours in the ambient (75° in temperature and 25-30% in relative humidity), their frequency responses were measured again to complete one cycle (labeled as “Dry” condition);

The steps from (b) to (d) were then repeated again as necessary.

One way to test the efficacy of the proposed superhydrophobic nano coatings is to apply an artificial salt fog to demonstrate how water accumulated on the devices. Omni and directional frequency responses can be measured. When the omni and directional modules were removed from the salt mist exposure during the very first cycle, it was found that all five coated modules still exhibited directional characteristics, while all untreated devices lost directionality. However, under dry test condition, these untreated devices eventually recovered.

This pattern continued in the subsequent cycles. The treated devices started to show degradation in sensitivity under wet condition after a third cycle; however, they still retained very good directional performance. This can be further confirmed through anechoic chamber measurement of free field polar diagrams. On the other hand, the performance of untreated modules under wet condition deteriorated significantly for both omni and directional capsules. Sensitivity reductions of 50 dB or more were observed.

In addition, coated devices also recovered completely under dry condition. In contrast, the untreated units could not fully recover under dry condition.

In one embodiment a superhydrophobic coating may be applied to a protector of a transducer, such as a microphone.

It is understood that the present subject matter may be employed in other hearing assistance devices, and in the case of hearing aids, different hearing aid configurations. The teachings provided herein may be applied to designs including, but not limited to, behind-the-ear (BTE), in-the-ear (ITE), in-the-canal (ITC), completely-in-the-canal (CIC), and over or on the ear designs.

This application is intended to cover adaptations or variations of the present subject matter. It is to be understood that the above description is intended to be illustrative, and not restrictive. Thus, the scope of the present subject matter is determined by the appended claims and their legal equivalents.

What is claimed is:

1. A method for manufacturing a hearing assistance device to resist accumulation of unwanted materials, the method comprising:
assembling the hearing assistance device including a superhydrophobic portion.

2. The method of claim 1, wherein the superhydrophobic portion includes a superhydrophobic screen for a microphone.

3. The method of claim 1, wherein the superhydrophobic portion includes a microphone hood.

4. The method of claim 3, wherein the superhydrophopic portion further includes a superhydrophobic microphone screen.

5. The method of claim 1, wherein the superhydrophobic portion includes an area of a housing for the device.

6. The method of claim 5, wherein the superhydrophobic portion further includes a microphone hood.

7. The method of claim 5, wherein the superhydrophobic portion further includes a super hydrophobic microphone screen

8. The method of any of claims 1, wherein assembling the hearing assistance device includes assembling the hearing assistance device including a superhydrophobic portion with texture features having contact angles greater than 150 degrees.

9. The method of claim 1, wherein assembling the hearing assistance device includes assembling the hearing assistance device including a superhydrophobic portion with texture features having feature heights in the range of 10 nanometers to 1 micrometer.

10. A hearing assistance device comprising:
hearing assistance electronics;
a microphone in communication with the hearing assistance electronics; and
a case for housing the hearing electronics,
wherein the device includes one or more superhydrophobic portions.

11. The device of claim 10, wherein the one or more superhydrophobic portions includes a first area around a microphone port of the device.

12. The device of claim 11, wherein the one or more superhydrophobic portions includes a microphone screen of the device.

13. The device of claim 10, wherein the one or more superhydrophobic portions includes an first area around a front microphone port of the device.

14. The device of claim 13, wherein the one or more superhydrophobic portions includes a second area around a rear microphone hood of the device.

15. The device of claim 14, wherein the one or more superhydrophobic portions includes a microphone screen of the device.

16. The device of claim 10, wherein the superhydrophobic portion includes an area around a rear microphone hood of the device.

17. The device of claim 10, wherein the superhydrophobic portion includes a microphone screen of the device.

18. The device of claim 10, wherein the superhydrophobic portion includes texture features having contact angles greater than 150 degrees.

19. The device of claim 10, wherein the superhydrophobic portion includes texture features having feature heights in the range of 10 nanometers to 1 micrometer.

20. The device of claim 10, wherein the case is a behind-the-ear case.

21. The device of claim 10, wherein the case is a in-the-ear case.

22. The device of claim 10, wherein the case is an in-the-canal case.

23. The device of claim 10 wherein the case is a completely-in-the-canal case.
